(19) United States
(12) Patent Application Publication
(10) Pub. No.: US 2012/0085826 A1
(43) Pub. Date: Apr. 12, 2012

(54) Data Storage Card

(76) Inventor: Albert Talker, New York, NY (US)

(21) Appl. No.: 12/902,132

(22) Filed: Oct. 11, 2010

(51) Int. Cl. G06K 19/12; G06K 19/067; G06K 19/06

(52) U.S. Cl. 235/492; 235/493; 235/494

(57) ABSTRACT

A data storage card having magnetic recording material and printed bar-codes spaced apart on its surface and optional embedded Integrated Circuit and or RFID device imbedded in body of the card. The card is wallet-size and preferably the strips run parallel to the lengthwise dimension of the card and the barcodes printed on the free space not occupied by the magnetic recording material. The back side of the data storage card includes means to attach or imbed additional data storage means including magnetic recording strips, attachable printed bar-code, Integrated Circuits, electronic memory and RFID devices.

### FIELD OF THE INVENTION

The invention relates to data storage cards and more particularly to data storage cards which can be used to store information related to identification, loyalty cards, credit cards, insurance, personal medical histories and the like.

### BACKGROUND OF THE INVENTION

The invention relates to combined data storage cards and more particularly to data storage cards using one or more data storage means which can be used to store information related to loyalty cards, credit cards, identification cards, insurance, personal medical histories and the like.

### Loyalty Cards:

The present invention relates to one card used for promotions and discounts offered to consumers which account or ID is stored in the data card which is shared between retailers.

Loyalty programs are commonly used by retailers to improve consumer loyalty and to lure consumers away from their competitors. In a typical loyalty program, loyalty cards are issued to consumers. Loyalty cards reward consumers for frequenting and making purchases at stores covered by the loyalty cards. When a loyalty card is used, advertised promotions are given to the consumer in the form of discounts or points that are redeemed at the point of sale as a credit against a purchase made by the consumer.

With an increase in the number of retailers (both brick-and-mortar stores and online stores) offering loyalty programs, retailers are now constantly striving to offer “better” loyalty programs than their competitors in an effort to improve consumer loyalty and also to lure consumers away from their competitors. Accordingly, there is need for loyalty programs that are more flexible, easier to use by the consumers, and offer better benefits than existing loyalty programs. Retailers also would like to implement the “better” loyalty programs without incurring significant costs or making significant changes to their existing infrastructure. The data storage card of the present invention can be used and shared by different retailers.

### Credit and Debit Cards:

The most common types of credit and debit cards in use today are magnetic stripe type cards. The standardized format used for such cards includes indicia on a front side of the card. Such indicia identify the card owner, an account number, a card type, a card issuer, an expiration date as well as possibly other information. The rears of such cards have a magnetic stripe supported thereon. The magnetic stripe includes several tracks of information. This information includes magnetic indicia representative of the information found on the front of the card as well as other information that is used in processing transactions electronically. Magnetic stripe cards are commonly used for credit card types such as MasterCard®, VISA®, Discover®, American Express®, Diner's Club® and others.

Most people also carry credit or debit cards, which allow them to access money in their checking, and savings accounts using automated banking machines. Some debit cards also function as credit cards. Most debit cards in use today are magnetic stripe cards similar in format to credit cards.

Due to the convenience of using credit and debit cards most people carry several such cards in their wallet. Because of financial incentives associated with the issuance and sponsorship of credit cards, many users are offered cards by different banks, clubs, fraternal organizations and merchandising organizations. As a result it is not uncommon for people to have several different MasterCard® and VISA® accounts. This gives consumers the opportunity to take advantage of premiums such as frequent flyer miles and rebates offered by card sponsors. Having several different credit cards also enables consumers to take advantage of the credit limits on all their cards. While having many credit and debit cards is a benefit to consumers, it also requires them to carry several cards.

Most individuals also carry a number of other objects or cards, which include machine-readable indicia. These often include for example, a health insurance card, which indicates that a person is a member of a particular group insurance plan. Such cards are often magnetic stripe cards similar to credit cards. Alternatively such health insurance cards may include bar code indicia or other visible indicia, which can be read with a scanner. Some health insurance cards include both visible and magnetic indicia. Persons who are members of a health insurance plan can identify themselves and their account to medical providers by showing their card, which can be read or scanned by appropriate devices.

Persons also commonly carry other types of cards with RFID, bar-codes or Integrated circuits. These may include for example, library cards, identification or access cards, employee identification cards, student identification cards, driver's license cards, professional license cards and other types of card like objects. The magnetic or visible indicia on these cards are usually read when presented by the cardholder to identify the person as an authorized user of services or facilities.

Another type of card, which has been developed, is the stored value card commonly referred to as a “smart card”. Stored value cards are similar to credit and debit cards in construction in that they include a front side which has raised identifying indicia which can be transferred to a carbon or carbonless multipart form. Such cards also commonly include a magnetic stripe including magnetic indicia, which enables the card to work like any other credit or debit card. Stored value cards also include a programmable memory mounted on the card. Such programmable memory stores data representative of cash value. The value on the stored value card can be used like cash by the bearer to purchase goods or services. The stored value data on the card is also often encrypted or stored using schemes to prevent fraud or tampering therewith.

Stored value cards, like debit and credit cards, require the customer to interact with a stationary terminal device to utilize the card. For example, in the case of credit cards, credit is obtained when the customer presents their card to a merchant. The merchant (unless they process transactions manually) utilizes a point of sale or electronic funds transfer terminal to charge an amount to the customer's account and credit the merchant's account. Similarly the use of a debit card requires that the user present their card to an automated banking machine such as an ATM. The ATM operates to add or deduct amounts from the user's account as funds are deposited or received by the user. Similarly, stored value cards are used in connection with a stationary terminal device such as an electronic funds transfer terminal or automated banking machine which has the special capabilities to handle the particular type of stored value card used. The terminal modifies the value information stored in memory on the card to reflect the addition or subtraction of value represented thereon as transactions are conducted.

Thus there exists a need for a card and a method that can reduce the number of credit, debit and other cards or card like objects that a person must carry while still obtaining the benefit of carrying all such cards and objects individually.

There further exists a need for an apparatus and method, which gives a single card the ability to be used as a substitute for any one of a plurality of credit, debit or other cards.

A listing of patents which are believed to have some pertinence to the present invention follow: TABLE-US-00001

| Patent Number | Inventor | Date of Issue |
|---|---|---|
| 6,954,740 | Talker(The | Oct. 11, 2005 |
| | inventor of | |
| | this application) | |
| 5,326,964 | | |
| 5,317,636 | | 1994 |
| 5,276,311 | Hennige | Jan. 04, 1994 |
| 5,255,941 | Solomon | Oct. 26, 1993 |
| 4,947,027 | Kashkashian, Jr | Oct. 13, 1987 |
| 4,707,594 | Roth | Nov. 17, 1987 |
| 4,697,073 | Kara | Sep. 29, 1987 |
| 4,587,413 | Hoppe et al | May 06, 1986 |
| 3,902,262 | Colegrove et al | Sep. 02, 1975 |
| 3,833,929 | Kirley | Sep. 03, 1974 |

### Parent Case Text

### CROSS-REFERENCES TO RELATED APPLICATIONS

The present application also incorporates by reference for all purposes the entire contents of U.S. application Ser. No. 11/349,655 filed on Feb. 8, 2006.

U.S. Pat. No. 6,954,740 issued in 2005 issued to the undersigned inventor teaches an “Action verification system using central verification authority” which does not include a multi account card. This current invention disclosure teaches of a “Multi Account Card” which can be cross-referenced to U.S. Pat. No. 6,954,740.

U.S. Pat. No. 5,255,941 issued in 1993 teaches an “Antifraud Credit Card Assembly” teaching a card, which includes a slidingly removable magnetic strip, to prevent unauthorized use of said card. Without the magnetic strip, the card is recognized as unusable. The present invention made subject this application differs in both method and apparatus for accomplishing the security verification, and card structure.

U.S. Pat. No. 5,326,964, apparently teaches a “Separable multi-account safety credit card system”, wherein the account numbers and the card are “mechanically detachable into two component parts, whereby that part upon which is embossed the credit account numbers may be separately carried from the individual identification part . . . ” to prevent unauthorized transactions. The present invention made subject this application differs in both method and apparatus for accomplishing the security verification, and card structure.

U.S. Pat. Nos. 5,317,636 and 5,276,311 teach smart credit cards having a QUERTY keypad or the like thereon for entry of passwords, and displays for indicating account information, signature information, or the like.

U.S. Pat. No. 4,697,073 teaches a credit card which appears to have separable the electronics, along with contact means for communicating with the verifying equipment.

The remaining patents cited are included for general information and research purposes, teaching various credit card systems, but do not appear to be as pertinent as the above-cited patents.

### GENERAL SUMMARY DISCUSSION OF THE INVENTION

The above patents may contemplate various alternative card systems, some programmable, some having removable indicia (magnetic or raised), but none contemplate the present system wherein the card can have multiple data storage devices and attaching means to install additional types of data storage devices.

The preferred embodiment of the present invention teaches a card body having the same basic dimensions and the same physical appearance of a standard credit card. As will be set forth below, an alternative embodiment of the present invention is also contemplated which utilizes a smart card which includes the virtual account and set of PINs stored in its memory.

As will be set forth below, an alternative embodiment of the present invention is also contemplated which utilizes a smart card which includes the virtual account and BIO data transmission mechanism.

As will be set forth below, an alternative embodiment of the present invention is also contemplated which utilizes a smart card which includes virtual accounts, PINs and BIO data stored in storage means and data transmission mechanism used to transmit/receive the stored data.

It is thus an object of the present invention to provide a multi account data storage card which is inexpensive to manufacture, and easy to operate.

It is another object of the present invention to provide a secure multi account card system comprising display means, which lists accounts by name on the card's body.

It is another object of the present invention to provide a method for preventing card theft, utilizing a central database, and means for capturing and transmitting activation data.

It is another object of the present invention to allow the use of a PIN/KEY, which can be used to validate an Entity's identity and its authorization through the use of a PIN/KEY code entered into the data storage card using a data entry unit.

For the foregoing reasons, there is a need for an easily implemented data storage card with one or more account data. It is to such a system that the present invention is directed.

### BRIEF DESCRIPTION OF THE DRAWINGS

FIG. 1 is a schematic, diagrammatic view of a data storage card in accordance with the present invention, showing the card, the magnetic strips and the printed bar-codes.

FIG. 2 is a schematic, diagrammatic view of a data storage card in accordance with the present invention, showing the card, optionally embedded devices including RFID memory circuit or a computer chip, the magnetic strips and the printed bar-codes.

FIG. 3 is a schematic, diagrammatic view of a data storage card in accordance with the present invention, showing the card, embedded RFID device, embedded Integrated Circuit, the magnetic strips and the printed bar-codes.

FIG. 4 is a schematic, diagrammatic view of a data storage card in accordance with the present invention, showing attaching means used to attach additional data storage means onto the card, attachable RFID device, attachable bar-code strip and attachable magnetic strip.

FIG. 5 is a schematic, diagrammatic view of a data storage card in accordance with the present invention, showing attached RFID device, attached bar-code strip and an attached magnetic strip.

FIG. 6 is a schematic, diagrammatic view of a data storage card in accordance with the present invention, showing attached RFID device, attached bar-code strip and an attachable magnetic strip.

FIG. 7 is a schematic, diagrammatic view of a data storage card operating in accordance with the present invention, showing a smart card with PIN/Key or account selection control and an optional BIO identification unit embedded in the card.

FIG. 8 is a schematic, diagrammatic view of a data storage card operating in accordance with the present invention, showing an Integrated Circuit smart card with PIN/Key or account selection control and a smart card display. It also includes a schematic view to show data card input which includes optional terminal used to input or retrieve data from the data storage card by a Financial Enterprise/Clearing Agent entity using data transmission and an input device.

FIG. 9 is a schematic, diagrammatic view of a data storage card operating in accordance with the present invention, depicting a smart card with PIN/Key or account selection control and a smart card display and a schematic view depicting data card input entered by an entity using data input devices.

For a further understanding of the nature and objects of the present invention, reference should be had to the following detailed description, taken in conjunction with the accompanying drawings, in which like parts are given like reference numerals.

### DETAILED DESCRIPTION OF THE INVENTION

### Definitions of Terms

Entity (17)—The term “Entity” as used herein means an individual, company, vendor or other organization which is able to enter data into the data storage card.

Financial Enterprise/Clearing Agent (12)—The term “Financial Enterprise/Clearing Agent” as used herein means an company, organization or other Entity which can embed and communicate with systems which embed the information in the data storage card and/or processes information retrieved from the data storage card.

Communication Link/Computer Network (32)—The term “communication link” interchangeably referred also as “Computer Network” refer to any suitable communication link, which permit communications (e.g. Internet, computer network, telephone). It should be understood that the term “communication link” is not limited to “Internet” or any other particular system or type of communication link. That is, the term “communication link” is intended only to refer to any suitable communication system, including extra-computer system and intra-computer system communications. Examples of such communications systems include internal busses, local area networks, wide area networks, point-to-point shared and dedicated communications, infra-red links, microwave links, telephone links, CATV links, Satellite and radio links and fiber-optic links. The term “communication link” can also refer to any suitable communication system for sending messages between remote locations, directly or via a third party communication provider such as AT&T. In this instance, messages can be communicated via telephone or facsimile or computer synthesized voice telephone messages with or without voice or tone recognition, or any other suitable communications technique.

It should be understood that each of the communication links are shown and described separately herein for the sole purpose of clearly illustrating the information being communicated between the Central Authentication Enterprise, the Merchant and the Entity. In operation, the communication links may not be separate communication links but may be a single communication link.

“PIN”—The term “PIN” or “Pin” or KEY or PIN/KEY refer to Personal Identification Numbers, Key Codes, public/private keys or Tokens. Each Entity will have sets of individualized PINs/Keys linked to his virtual account which one of them may be uniquely associated with, or identify a particular transaction, activity or other item that needs security verification. The PINs/Keys may be stored with it virtual account number suitable for identifying a particular transaction. These PINs/Keys may be generated using a predetermined strategy or arbitrary generated by a computer. The PINs/KEYs may include a predetermined strategy formula to generate further sets of PINs/KEYs that can be used to verify future transactions. The Entity can only perform the selection of the appropriate formula. PINs/KEYs can also be supplied to the Entity by a form of printed list or labels, or by using electronic means wherein the Entity may able to select a PIN/KEY and supply the PIN/KEY to the merchant.

BIO data—The term “BIO” as used herein means any personal BIO data or BIO identification confirmation data including finger prints, retinal scan, face recognition, voice identification, and other personal identification features.

BIO Reader Device (16)—The term as used herein means any personal BIO data or BIO identification confirmation data including finger prints, retinal scan, face recognition, voice identification, and other personal identification features stored in the data storage card and used for identification purposes.

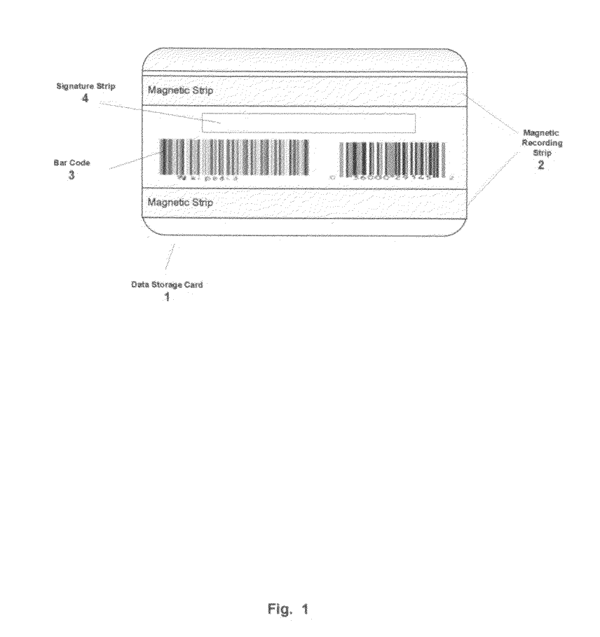

### Description of Components—(Referring to FIG. 1-FIG. 9.)

### Data Storage Card

The data storage card 1 may have the dimensional configuration of conventional credit and debit cards. It can include a magnetic stripe or bar-code print on a rear face thereof. The magnetic stripe 2 is capable of holding magnetic indicia similar to the magnetic stripes on conventional debit, credit and similar cards. The bar-code print 3 is capable of holding account data similar to the data held in magnetic stripes on conventional debit, credit and similar cards.

As later explained, data storage card 1 is designed to be used as a substitute for a plurality of varied types of credit, debit, loyalty, Identification, membership and other cards. However, in embodiments of the invention, data storage card 1 may include information on the face or rear thereof so as to identify the particular user to whom the card belongs, an issuer of the card, as well as other data. In some embodiments, the front side of the card may include raised numbers and letters corresponding to a particular virtual account and from which an impression may be made onto a carbon or carbonless form. In some embodiments, the front side of the card may include printed, glue labeled, or embossed (raised) captions including numbers and letters, corresponding to accounts titles/names linked to the owner of data storage card.

For example, information on the face of the card may correspond to a user's MasterCard®, VISA®, American Express®, Discovery®, checking accounts, investment accounts, or other accounts. This enables the exemplary card to be used as the user's regular credit card when purchasing goods or services in establishments that do manual processing of credit card transactions. Of course while in the embodiment discussed, conventional credit card indicia may be included on the front of the card, in other embodiments special indicia may be presented on the back of the card.

As shown in FIG. 1 the data storage card 1 includes two magnetic recording strips 2 and two bar-codes 3 placed on the back of the card. In additional optional signature strip is adhered between the magnetic recording strips 2.

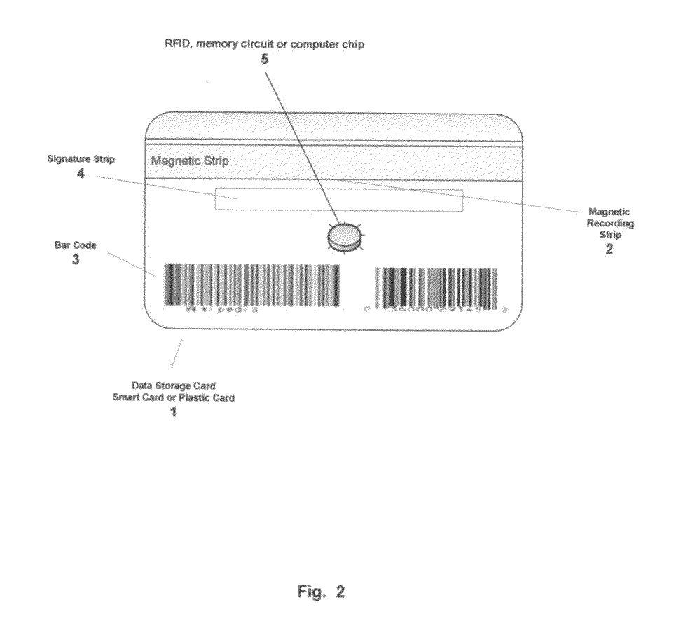

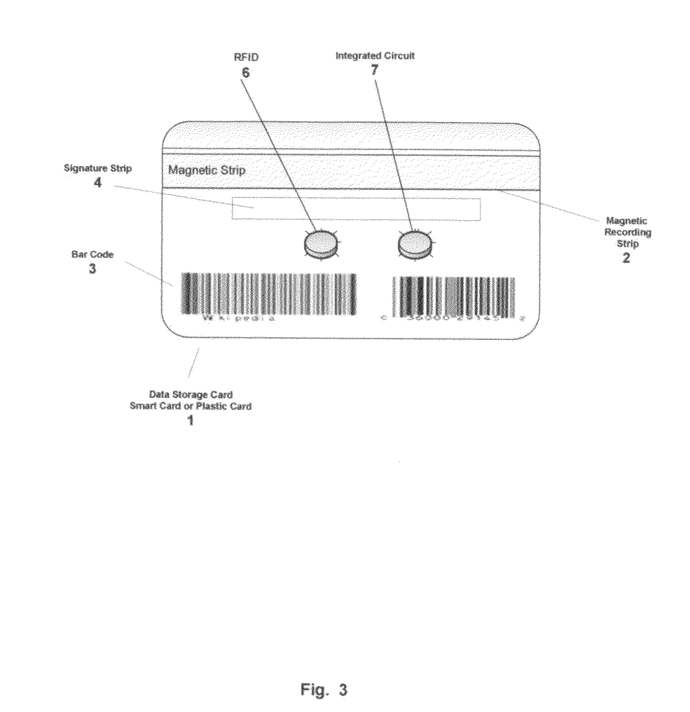

As shown in FIG. 2 and FIG. 3 the data storage card 1 includes two magnetic recording strips 2 and two bar-codes 3 placed on the back of the card. In additional optional signature strip is adhered between the magnetic recording strips 2. In addition an RFID, memory circuit or computer chip 5 is imbedded in the body of the card. The data stored in RFID, memory circuit or computer chip 5 may be the same data encoded on a magnetic strip on the back of a card or any other form of stored data. The said stored data may also include a personal account number (PAN), personal identification number (PIN), expiration date, cardholder name, and/or a card security code, e.g., a three-digit code commonly found on the back of payment cards. In addition, the said stored data might include an electronic cardholder signature or biometric data, such as a digital fingerprint. The stored data may also include a dynamic security code, such as may be found in a radio frequency identification (RFID) device embedded in a payment card.

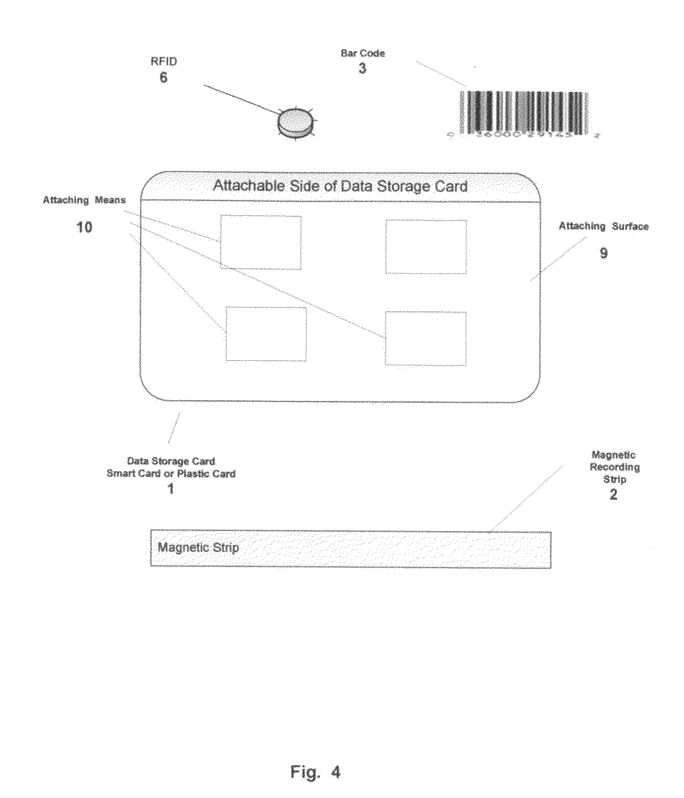

As shown in FIG. 4 the data storage card 1 front surface includes attaching means 10 used to attach additional data storage devices onto the face of the card located on the attaching surface 9 of the data storage card. The attaching means include glue-able surface, tapes, magnetic tapes, sticky tapes, attaching groves, staples, pins, or liners. The attachable data storage devices depicted in FIG. 4 includes a magnetic recording strip 2 and an attachable bar-code 3 placed on the back of the card. In additional an optional RFID attachable device 6 is depicted

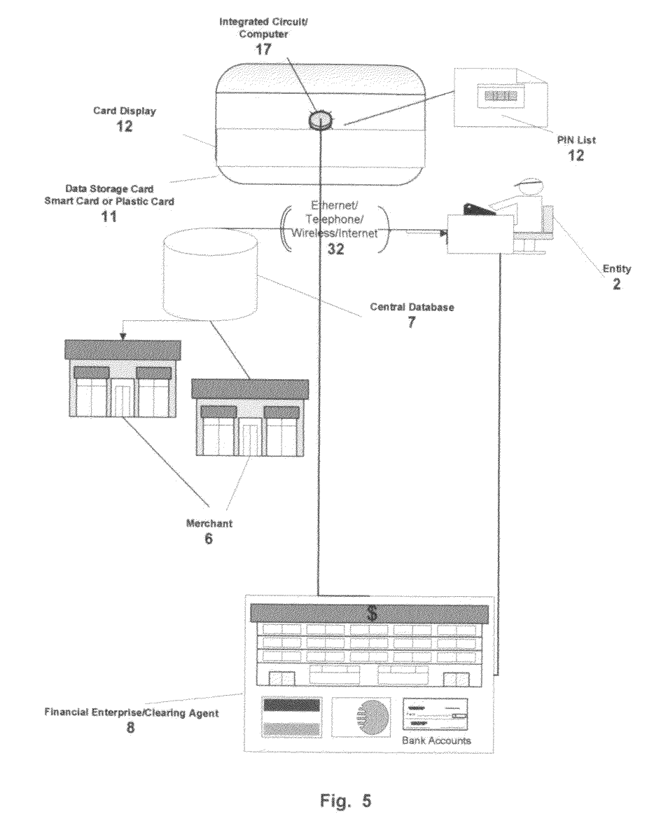

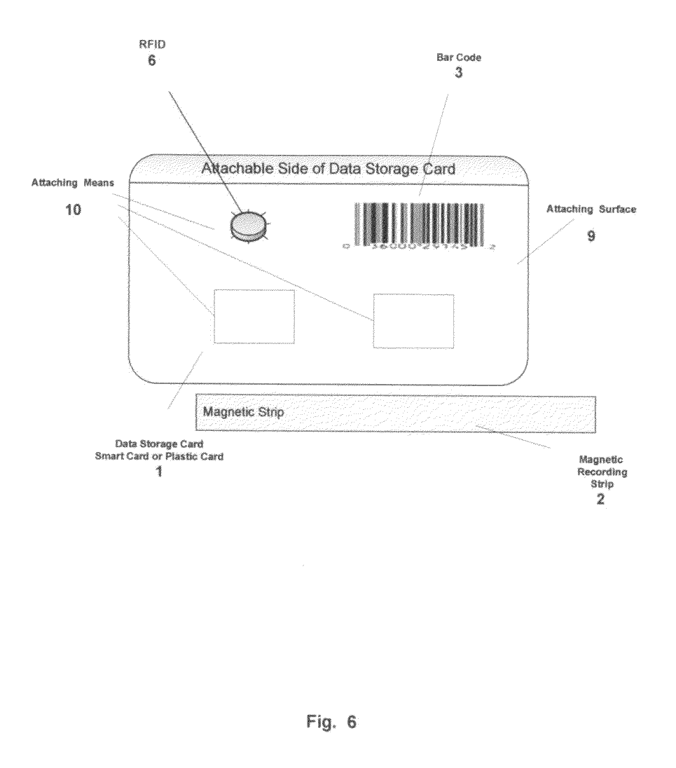

As shown in FIG. 5-6 the attachable data storage devices are attached using attaching means 10 onto the attaching surface 9 of the data storage card 1.

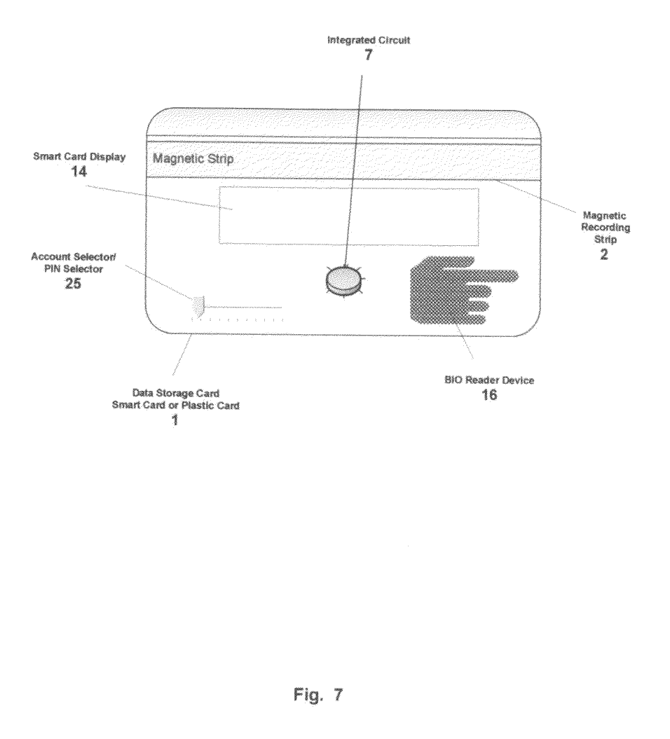

As shown in FIG. 7 in the embodiment shown, the data storage card may further include an input device, which includes a manual input device for selecting Account/PIN 25. The Account/PIN selector 25 can be used for entry or selection of the user's PIN or Control Digits stored in the card. The data storage card may also include a smart card electronic display 14 on the card's face thereof. In one exemplary form of the invention smart card display 14 is an LCD type display or other suitable display that may be used for displaying words, graphics and other visible indicia in a manner later explained. When pressing the button or slider 25, the electronic display screen 14 begins a scrolling through the listed data in memory. The card may include only buttons to scroll up/down (button or slider 25). These scroll up and scroll down buttons, are pressed by a user to selectively display items on the display.

The data storage card may further include data representative of visual indicia, which are found on a plurality of cards or other objects associated with the virtual account. The visible indicia may include for example, bar code indicia representative of a user's real account. Alternatively such visible indicia may include bar code, alpha numeric accounts or other indicia associated with a membership I.D., Credit Cards, Checking Accounts, student I.D., employee access card, driver's license, or other types of data objects. The visible indicia displayed using smart card display 14 may also include account data, or other account holder data. The data storage card 1 may also include data representative of icons or other graphics as well as data representative of accounts stored in the said card.

Alternative embodiments of the invention may include a bio reader device 16. The bio reader device may include hardware and software components that can be used to sense a characteristic of a user, which uniquely identifies the person as an authorized user. In some embodiments the biometric reader device 16 may include a fingerprint reading device. Alternatively, the reader may include an audio input device, which can be used to identify a user by voice. Alternatively, visual readers for identifying unique visible features or a combination of identifying features of the user may be used. The data storage memory of the card may include data representative of the identifying biometric features of the authorized user or users. This stored data is used to enable authorized users of the card to operate the card while others are prevented from such operation

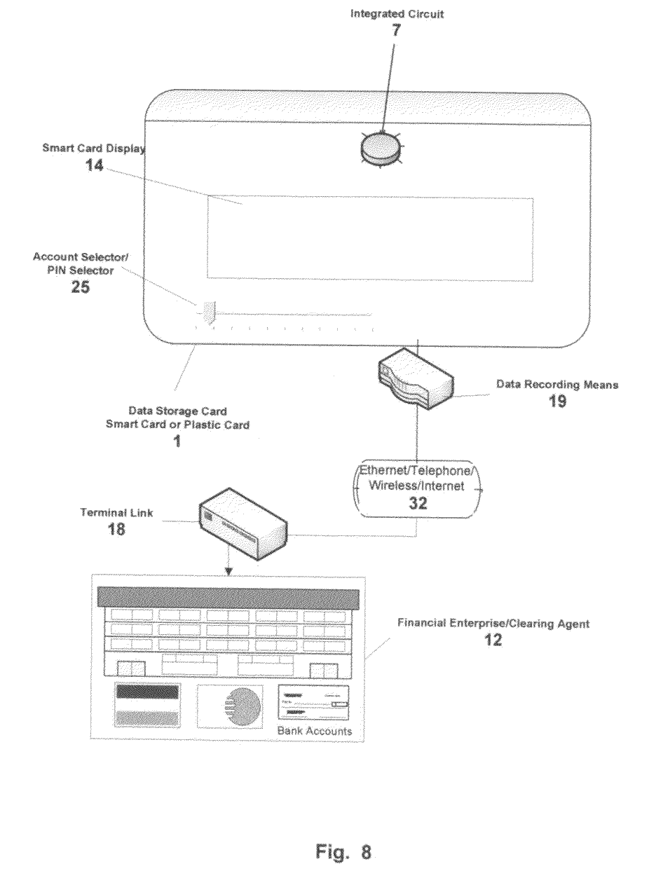

As shown in FIG. 8 is a view of a data storage card operating in accordance with the present invention, showing an Integrated Circuit smart card with PIN/Key or account selection control and a smart card display. It also includes a schematic view to show data card input which includes optional terminal used to input or retrieve data from the data storage card by a Financial Enterprise/Clearing Agent entity using data transmission and an input device. In the embodiment shown, the data storage card may further include an input device, which includes a manual input device for selecting Account/PIN 25. The Account/PIN selector 25 can be used for entry or selection of the user's PIN or Control Digits stored in the card. The data storage card may also include a smart card electronic display 14 on the card's face thereof. In one exemplary form of the invention smart card display 14 is an LCD type display or other suitable display that may be used for displaying words, graphics and other visible indicia in a manner later explained. When pressing the button or slider 25, the electronic display screen 14 begins a scrolling through the listed data in memory. The card may include only buttons to scroll up/down (button or slider 25). These scroll up and scroll down buttons, are pressed by a user to selectively display items on the display.

The data storage card may further include data representative of visual indicia, which are found on a plurality of cards or other objects associated with the virtual account. The visible indicia may include for example, bar code indicia representative of a user's real account. Alternatively such visible indicia may include bar code, alpha numeric accounts or other indicia associated with a membership I.D., Credit Cards, Checking Accounts, student I.D., employee access card, driver's license, or other types of data objects. The visible indicia displayed using smart card display 14 may also include account data, or other account holder data. The data storage card 1 may also include data representative of icons or other graphics as well as data representative of accounts stored in the said card.

In this embodiment the terminal link 18 is used to communicate data using data communication links 32 with the data recording means 19 that is used to transfer data into the card's data storage devices. In the embodiment shown, the data reading and writing functions are combined schematically and are schematically shown using data recording means 19 and data terminal link 18. However, it should be understood that these are separate functions and may be carried out through separate arrangements of hardware and software. The card 1 further includes the hardware and software devices required to read data from and write data into the card's data storage devices using data recording means 19 which are known in the art in their functionality.

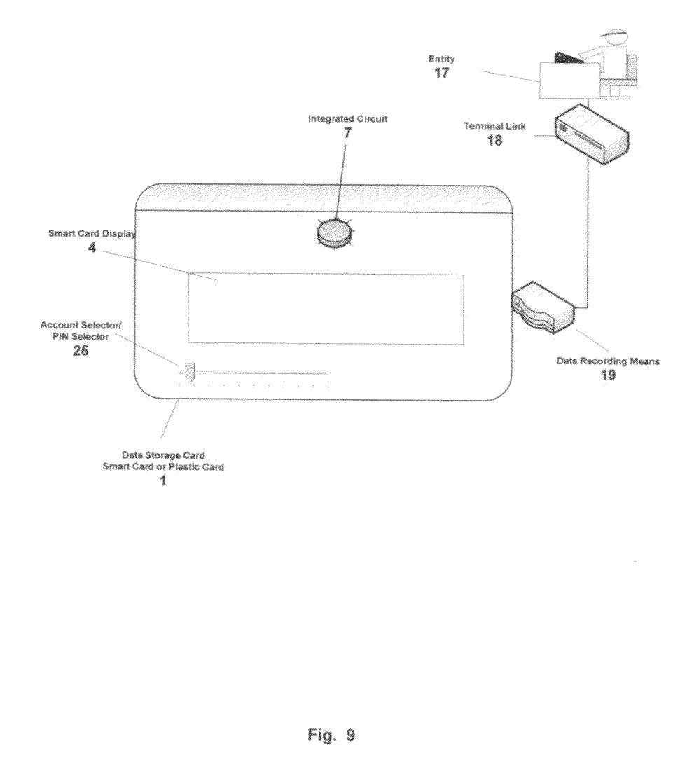

As shown in FIG. 9 is a view of a data storage card operating in accordance with the present invention, showing an Integrated Circuit smart card with PIN/Key or account selection control and a smart card display. It also includes a schematic view to show data card input which includes optional terminal used to input or retrieve data from the data storage card by a Financial Enterprise/Clearing Agent entity using data transmission and an input device. In the embodiment shown, the data storage card may further include an input device, which includes a manual input device for selecting Account/PIN 25. The Account/PIN selector 25 can be used for entry or selection of the user's PIN or Control Digits stored in the card. The data storage card may also include a smart card electronic display 14 on the card's face thereof. In one exemplary form of the invention smart card display 14 is an LCD type display or other suitable display that may be used for displaying words, graphics and other visible indicia in a manner later explained. When pressing the button or slider 25, the electronic display screen 14 begins a scrolling through the listed data in memory. The card may include only buttons to scroll up/down (button or slider 25). These scroll up and scroll down buttons, are pressed by a user to selectively display items on the display.

The data storage card may further include data representative of visual indicia, which are found on a plurality of cards or other objects associated with the virtual account. The visible indicia may include for example, bar code indicia representative of a user's real account. Alternatively such visible indicia may include bar code, alpha numeric accounts or other indicia associated with a membership I.D., Credit Cards, Checking Accounts, student I.D., employee access card, driver's license, or other types of data objects. The visible indicia displayed using smart card display 14 may also include account data, or other account holder data. The data storage card 1 may also include data representative of icons or other graphics as well as data representative of accounts stored in the said card.

In this embodiment the terminal link 18 is used to communicate data using data communication links 32 with the data recording means 19 that is used to transfer data into the card's data storage devices. In the embodiment shown, the data reading and writing functions are combined schematically and are schematically shown using data recording means 19 and data terminal link 18. However, it should be understood that these are separate functions and may be carried out through separate arrangements of hardware and software. The card 1 further includes the hardware and software devices required to read data from and write data into the card's data storage devices using data recording means 19 which are known in the art in their functionality

In this embodiment the a schematic view depicting input from a remote location entered by an entity 17 using data input devices. The data input devices many include wireless means so data can be transmitted from the entity's into the card's data storage devices using data recording means 19. The entity's terminal 17, which can be comprised of a computer and communication devices, will communicate with the data recording means 19 which will record the communicated data into the card's data storage devices.

Data Input Devices used by entity 17 may include one or more of the following:

1. Portable terminal.

### 2. Keyboard

### 3. Keypad

### 4. Modem

### 5. Computer

### 6. Laptop

### 7. PDA

8. Voice Recognition mechanism

### 9. Cam Camera

### 10. Bar Code Reader

11. Magnetic stripe writer

### 12. Scanner

13. Any other digital input device

The data input device is preferably sufficiently small so as to be readily portable. The data recording device 19 operates in conjunction with the data storage card or alternatively can be built in the card. The data recording device 19 can include a reading device; which is operative to read the data from the card's data storage devices. In some embodiments the data recording device 19 may further include object-reading devices such as a magnetic stripe reader and a bar code scanner. Such input devices are used to read magnetic indicia or bar code from the card, and then accept further data input from the entity using data input devices for example, a keypad, and then transfer such information into the data storage card's data storage devices.

The data storage card 1 can also have security measures to prevent unauthorized access for usage of the card. For example, a card user may be required to provide at least one identifying input prior to being permitted to use the card. This may include the card user providing a biometric input, such as a fingerprint, to the card, or input a pass code before using the card. Alternatively, the card can wirelessly transmit captured BIO data to the CAE for external authorization.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

1. A data storage card for use with a card reader comprising,
a wallet-size card having opposed sides and a length equal to or exceeding a width,
a first strip of magnetic recordable material adhered to the front surface of the card, and one or more bar-codes printed on the surfaces of the card, and a second strip of magnetic recordable material adhered to the card.

2. The card of claim 1 wherein said first strip and said bar-codes are located on the same side of said card.

3. The card of claim 1 wherein said first strip and a second strip are adhered to opposite sides of said card.

4. The card of claim 1 wherein said first and second strips are disposed parallel to each other and spaced apart on the same side of said card, said strips extending in the lengthwise direction and option one or more bar-codes are printed in the space between the strips.

4. The card of claim 1 wherein the opposite surface of the said card is used to attach additional magnetic strips using attaching means.

5. The card of claim 1 wherein the opposite surface of the said card is used to attach additional printed bar-codes strips using attaching means.

6. The card of claim 1 wherein the opposite surface of the said card is used to attach additional electronic means including RFID, memory circuit and computer chips using attaching means.

7. A data storage card for use with a card reader comprising,
a wallet-size card having opposed sides and a length equal to or exceeding a width,
a first strip of magnetic recordable material adhered to the front surface of the card, and one or more bar-codes printed on the surfaces of the card, and electronic means including RFID, memory circuits and computer chips assembled in the body of the card.

8. The card of claim 7 wherein said first strip and said bar-codes are located on the same side of said card.

9. The card of claim 7 wherein said first strip and a second magnetic strip are adhered to opposite sides of said card.

10. The card of claim 7 wherein said first strip and a second magnetic strip are disposed parallel to each other and spaced apart on the same side of said card, said strips extending in the lengthwise direction and optional one or more bar-codes are printed in the space between the strips.

11. The card of claim 7 wherein the opposite surface of the card is used to attach additional magnetic strips using attaching means.

12. The card of claim 7 wherein the opposite surface of the card is used to attach additional printed bar-codes strips using attaching means.

13. The card of claim 7 wherein the opposite surface of the card is used to attach additional electronic means including RFID, memory circuit and computer chips using attaching means.

14. The card of claim 7, wherein said card includes memory, wherein the memory is operative to store data associated with at least one account, wherein said memory can be used to store data associated with each said account, wherein the said card optionally includes at least one display device, wherein said display device is operative to electronically display data corresponding to an account associated with the data.

15. The card of claim 7, wherein said card further comprises terminal interface means for communicating and receiving data from outside peripherals and store the said received data in the said card internal memory.

16. The card of claim 7, wherein said card includes input means including; (a) electronic buttons, (b) computer input, (c) mechanical input.

17. A data storage card having generally about the same dimensions as a standard credit card comprising,
one or more strips of magnetic recordable material adhered to the front surface of the card, and
one or more bar-codes printed on the surfaces of the card, and said card having data storage means, said data storage means including, (a) magnetic strip, (b) smart card, (c) RFID device (d) bar code, (e) electronic memory, (f) computer.

18. The card of claim 17, wherein said card further comprises terminal interface means for communicating and receiving data from outside peripherals and store the said received data in the said card internal memory.

19. The card of claim 17, wherein said card includes input means including; (a) electronic buttons, (b) computer input, (c) mechanical input.
